(19) United States
(12) Patent Application Publication
(10) Pub. No.: US 2026/0004356 A1
(43) Pub. Date: Jan. 1, 2026

(54) Techniques for Dynamic Data Validation

(71) Applicant: UNITEDHEALTH GROUP, INCORPORATED, Minnetonka, MN (US)

(72) Inventors: Amy L. Neftzger, Nashville, TN (US); Erin H. Macphaul, Waltham, MA (US); Shashank Kapoor, Toronto (CA); Jatin Sachdeva, Delhi (IN); Krystine D. Mahmood, Alpharetta, GA (US); Mayank Kumar, Austin, TX (US)

(21) Appl. No.: 18/756,923

(22) Filed: Jun. 27, 2024

(51) Int. Cl. G06Q 40/08

(52) U.S. Cl. CPC G06Q 40/08

(57) ABSTRACT

Techniques for dynamic data validation are disclosed herein. An example computer-implemented method includes receiving entity data associated with an entity, the entity data including locations of the entity at respective times. The method further includes determining, by executing a dynamic period algorithm, periods based on the entity data; and applying a machine learning (ML) model to the entity data and the periods. Applying the ML model includes determining, for at least one period, one or more confidence values associated with each location at the respective times included in the period based on (i) a frequency associated with each location and (ii) a period distance value relating a current time to the period. The ML model also outputs a ranking for each location included in the period based on the one or more confidence values. The method further includes generating a data object indicating one or more of the ranked locations.

### TECHNICAL FIELD

The present disclosure generally relates to data validation techniques, and more particularly, to determining dynamic time periods for entity data and generating location rankings by applying a machine learning model to the entity data and the time periods.

### BACKGROUND

Consumers in many industries rely on service provider directories to make informed scheduling decisions. However, many directories rely on a service provider's self-reported address and phone number, which frequently lists an inaccurate physical practicing location (i.e., a “servicing location”). For example, in the healthcare industry, provider organizations often attempt to align all their providers with each of their billing addresses to facilitate efficient claim adjudication, but such billing addresses often do not reflect the provider's servicing location. Patients attempting to schedule visits to a physician are thereby misinformed and may miss critical treatment opportunities as a result of being unable to locate their physician.

Conventional techniques for validating servicing locations suffer from several drawbacks. Manual outreach efforts to validate servicing addresses (e.g., “Secret Shoppers”) are highly inefficient and commonly unsuccessful, as the contact points (e.g., administrators) typically do not have additional information beyond the provider's self-reported data and consequently confirm billing addresses without providing a servicing location. Conventional automated systems that validate servicing locations are inaccurate because they likewise lack access to true servicing location data and/or due to data inconsistencies. For example, spelling errors and/or abbreviations in either the location of record or the location identified on received documents result in numerous false negatives (i.e., correct servicing location is identified as an incorrect servicing location). Despite the adoption of techniques such as fuzzy logic, conventional automated techniques consistently fail to achieve location match/validation rates (i.e., location of record is servicing location) at or above 60%.

Therefore, in general, accurate and efficient data validation is an area of great interest, and conventional techniques can be insufficient for providing such accurate, efficient data validation. Accordingly, a need exists for techniques that provide users with accurate, efficient data validation and thereby mitigate the negative effects stemming from inaccurate, inefficient conventional techniques.

### SUMMARY

In some aspects, a computer-implemented method includes receiving, by one or more processors, entity data associated with an entity, the entity data including one or more locations of the entity at respective times. The computer-implemented method further includes determining, by the one or more processors executing a dynamic period algorithm, one or more periods based on the entity data, wherein at least one of the one or more periods includes at least one of the respective times. The computer-implemented method further includes applying, by the one or more processors, a machine learning model to the entity data and the one or more periods. Applying the machine learning model includes: determining, for at least one period of the one or more periods, one or more confidence values associated with each location at the respective times included in the at least one period based on (i) a frequency associated with each location and (ii) a period distance value relating a current time to the at least one period; and outputting a ranking for each location included in the at least one period based on the one or more confidence values. The computer-implemented method also includes generating, by the one or more processors, a data object indicating one or more of the ranked locations.

In some aspects, a system comprises memory and one or more processors communicatively coupled to the memory. The one or more processors are configured to receive entity data associated with an entity, the entity data including one or more locations of the entity at respective times. The one or more processors are further configured to determine, by executing a dynamic period algorithm, one or more periods based on the entity data, wherein at least one of the one or more periods includes at least one of the respective times. The one or more processors are further configured to apply a machine learning model to the entity data and the one or more periods. Applying the machine learning model includes: determining, for at least one period of the one or more periods, one or more confidence values associated with each location at the respective times included in the at least one period based on (i) a frequency associated with each location and (ii) a period distance value relating a current time to the at least one period; and outputting a ranking for each location included in the at least one period based on the one or more confidence values. The one or more processors are also configured to generate a data object indicating one or more of the ranked locations.

In some aspects, one or more non-transitory computer-readable storage media include instructions that, when executed by one or more processors, cause the one or more processors to: receive entity data associated with an entity, the entity data including one or more locations of the entity at respective times. The instructions, when executed by the one or more processors, further cause the one or more processors to determine, by executing a dynamic period algorithm, one or more periods based on the entity data, wherein at least one of the one or more periods includes at least one of the respective times. The instructions, when executed by the one or more processors, further cause the one or more processors to apply a machine learning model to the entity data and the one or more periods. Applying the machine learning model includes: determining, for at least one period of the one or more periods, one or more confidence values associated with each location at the respective times included in the at least one period based on (i) a frequency associated with each location and (ii) a period distance value relating a current time to the at least one period; and outputting a ranking for each location included in the at least one period based on the one or more confidence values. The instructions, when executed by the one or more processors, further cause the one or more processors to generate a data object indicating one or more of the ranked locations.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2A depicts an example dynamic data validation workflow, in accordance with various embodiments described herein.

FIG. 2B depicts an example dynamic time period determination and location ranking workflow, in accordance with various embodiments described herein.

FIG. 3 depicts a flow diagram representing an example computer-implemented method, in accordance with various embodiments described herein.

### DETAILED DESCRIPTION

Broadly speaking, the dynamic data validation techniques of the present disclosure accurately determine locations (e.g., servicing locations) corresponding to entities by analyzing recent entity locations in combination with dynamically determined time periods. More specifically, the techniques of the present disclosure determine time periods based on entity data using a dynamic period algorithm, from which the techniques of the present disclosure can determine confidence values for locations included in the entity data and rankings corresponding therewith. These ranked locations and/or data objects indicating the ranked locations generally relate to and/or otherwise indicate accurate servicing location(s) associated with the entity. The techniques of the present disclosure improve over conventional data validation techniques at least by: (1) generating more accurate outputs than conventional techniques and (2) generating such outputs more efficiently than conventional techniques.

As previously mentioned, and as compared to conventional automated processes, conventional manual techniques are dramatically less efficient. However, conventional automated data validation techniques also suffer from notable drawbacks, such as inaccuracies stemming from lack of access to true servicing location data and/or data inconsistencies (e.g., different spellings, abbreviations, etc.). Many conventional techniques simply accept these inaccuracies and provide estimates indicating the reliability (or lack thereof) of the provided data. Conventional techniques that attempt to eliminate these issues typically rely on increasing/maximizing the quantity of data used to generate their data. However, such an approach leads to significantly reduced processing and/or other resource (e.g., storage resource) efficiency when using an enormous volume of data, and still fails to achieve considerably improved accuracy (e.g., commonly less than 50%). Thus, conventional data validation techniques generally suffer from substantial inaccuracy and/or inefficiency.

As a specific example, in the healthcare industry, service provider locations are typically provided in network directories that rely on the service provider self-reporting the servicing location. In many instances, provider organizations attempt to align all service providers in the directory with their billing information (e.g., address, phone number) to facilitate efficient claim adjudication. Each service provider may have hundreds or thousands of claims in a given time period (e.g., weeks, months), resulting in a substantial quantity of data per provider. Conventional manual processes are unreliable and inefficient, and conventional techniques that provide reliability indicators to account for known/accepted inaccuracies are generally inaccurate regardless of the data volume. Conventional techniques that intend to benefit from an increased corpus of data are similarly unable to leverage such voluminous data as an advantage. Practically speaking, as the volume of claims data increases, conventional techniques consume correspondingly more processing resources (e.g., processing cycles, memory space, etc.) and time analyzing the claims data to generate a result. These analyses therefore become increasingly less efficient in proportion to the amount of claims data available. Moreover, despite the advantages such techniques have over manual techniques, match rates for these and other conventional techniques continue to remain below 60%, with many failing to exceed 50%.

By contrast, the present disclosure provides dynamic data validation techniques that overcome these issues experienced by conventional techniques to achieve accurate and efficient data validation. Namely, the present techniques include determining time periods based on received entity data by executing a dynamic period algorithm and applying a machine learning (ML) model to the entity data and time periods to determine location rankings. These elements, among others, take a non-intuitive approach that improves over conventional techniques.

Unlike conventional techniques, the techniques of the present disclosure do not automatically utilize all available data to determine location rankings, but instead dynamically determine one or more periods of data (e.g., 1, 2, 3, 6, 9, 12 months, etc.) for analysis based on entity data (e.g., entity type data, updates from the ML model, etc.). The ML model then analyzes the entity data and the periods collectively to output location rankings, such that the periods enrich/inform the ML model analysis beyond analyses typically performed by conventional systems that rely solely on the received location data. In particular, the ML model of the present disclosure determines confidence values for received locations based on both a frequency with which the location appears in the data, as well as a period distance value generally representing the timeliness/recency of the location based on the particular period(s) in which the location appears. As a result, the ML model of the present disclosure can output highly accurate (e.g., in some embodiments, 30-40% improved accuracy to conventional automated techniques) location rankings without requiring massive data samples that needlessly occupy valuable processing resources and time. Accordingly, the techniques of the present disclosure improve the functioning of a computer or computing system by (1) reducing the required processing resources (time and bandwidth) through significant reductions to the volume of data analyzed and (2) improving the accuracy of location determinations through ML analysis of data frequency and timeliness/recency, which conventional techniques fail to accomplish or consider.

Moreover, in certain embodiments where none of the initially generated confidence values satisfy a confidence value threshold, the techniques of the present disclosure can adjust the time periods to further improve the results output by the ML model. In these embodiments, the dynamic period algorithm and ML model are configured to iteratively determine periods and respective confidence values until at least one confidence value satisfies the threshold. The dynamic period algorithm iteratively expands the periods based on the entity data and feedback from the ML model to include additional entity data, such that the ML model analyzes an amount of data sufficient to yield at least one confidence value that satisfies the threshold. These embodiments therefore incrementally/iteratively increase the amount of data analyzed based on the specific entity to analyze a minimal requisite amount of data to validate the specific entity's location. Consequently, these embodiments improve over conventional techniques by further reducing the amount of required processing resources (time and bandwidth) by reducing the volume of data analyzed.

The techniques of the present disclosure thus also improve the functionality of a computing device (e.g., a hosting server such as a central server) at least by analyzing data in a particular way to enhance the accuracy and efficiency of the computing device. The dynamic period algorithm and machine learning model, executing on the computing device, determine and utilize one or more periods and entity data to output location rankings with an accuracy and efficiency not achieved using conventional techniques. That is, the present disclosure describes improvements in the functioning of the computer itself because the computing device more accurately and efficiently analyzes/utilizes data as a direct result of the dynamic period algorithm and machine learning model. This improves over the prior art at least because existing systems slowly analyze all available data, are incapable of accurately interpreting data inconsistencies, utilize highly inefficient manual processes, and/or are otherwise unable to analyze data with the accuracy and efficiency resulting from the disclosed dynamic period algorithm and machine learning model.

Moreover, the present disclosure includes effecting a transformation or reduction of a particular article to a different state or thing, e.g., transforming or reducing the analytical error/inaccuracy and inefficiency of a computing system (and associated subsystems/components/devices) from a non-optimal or error state (e.g., highly inaccurate and/or inefficient) to an optimal (or closer to optimal) state by determining highly relevant time periods with optimal and/or minimally sufficient data volumes, and consequently substantially reducing the error/inaccuracy and inefficiency of conventional data validation techniques.

Still further, the present disclosure includes specific features other than what is well-understood, routine, conventional activity in the field, or adding unconventional steps that demonstrate, in various embodiments, particular useful applications, e.g., determining, by the one or more processors executing a dynamic period algorithm, one or more periods based on the entity data, wherein at least one of the one or more periods includes at least one of the respective times; applying, by the one or more processors, a machine learning model to the entity data and the one or more periods, wherein applying the machine learning model includes determining, for at least one period of the one or more periods, a confidence value associated with each location included in the at least one period based on (i) a frequency associated with each location and (ii) a period distance value associated with the at least one period, and outputting a ranking for each location included in the at least one period based on the confidence values, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care context, the techniques described herein may be readily applied in any suitable field for any suitable purpose.

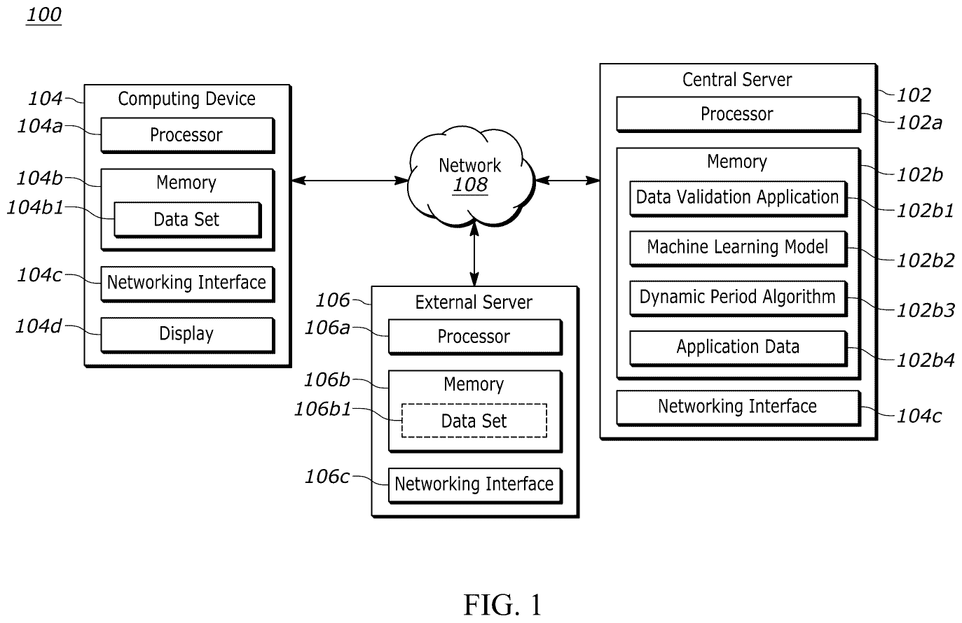

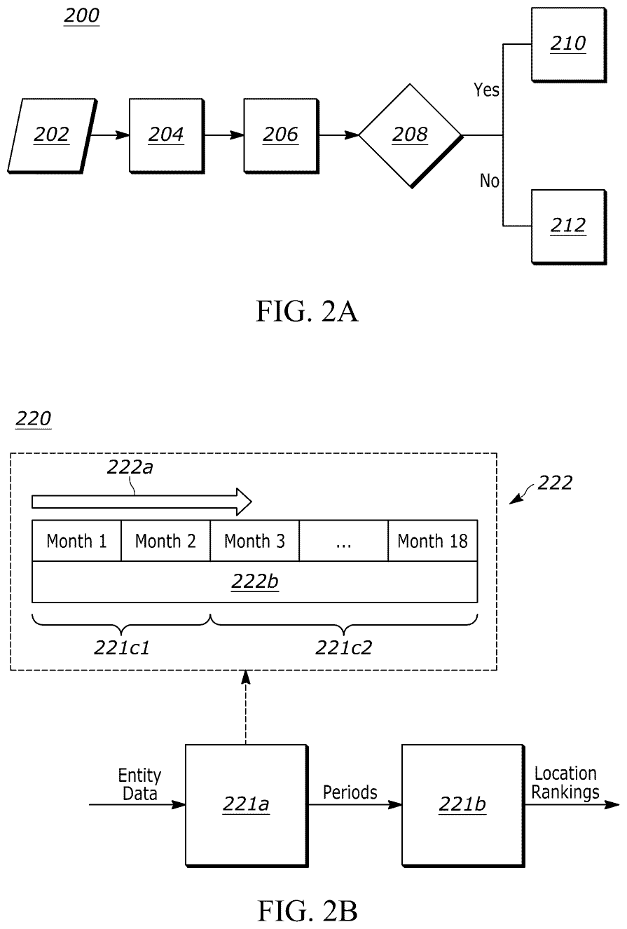

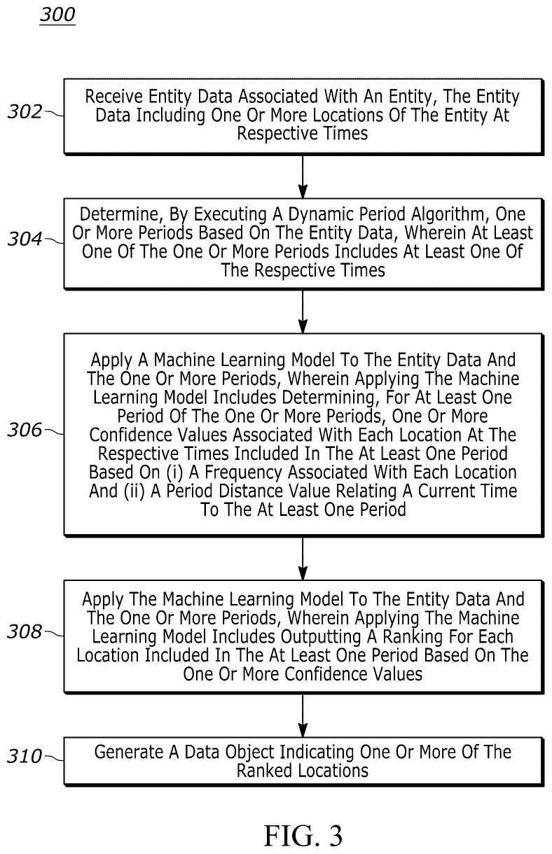

To provide a better understanding of the techniques described herein, FIG. 1 depicts an example computing environment in which techniques of the present disclosure may be implemented, and FIGS. 2A-2B illustrate how some of these system components may interact and/or otherwise process data to determine/generate time periods, confidence values, location rankings, and/or other output. FIG. 3 illustrates an example computer-implemented method for accurate and efficient dynamic data validation.

### Example Computing System

FIG. 1 depicts an example computing system 100 in which various embodiments of the present disclosure may be implemented. Depending on the embodiment, the example computing system 100 may determine/generate time periods, confidence values, location rankings, and/or any related values or combinations thereof. Of course, it should be appreciated that, while the various components of the example computing system 100 (e.g., central server 102, computing device 104, external server 106, etc.) are illustrated in FIG. 1 as single components, the example computing system 100 may include multiple (e.g., dozens, hundreds, thousands) of computing devices 104 and external servers 106 that are simultaneously connected to the network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the computing device 104 and/or the external server 106 may belong to a healthcare provider or hospital and the central server 102 may belong to a directory providing entity that aggregates/collects data from the healthcare provider or hospital for populating/updating a directory. In this example, the healthcare provider using the computing device 104 may transmit data (e.g., data set 104b1) to the central server 102, and the server 102 may execute a data validation application 102b1 to generate data objects indicating one or more ranked locations based on the data set 104b1. The central server 102 may also make the data object accessible to the healthcare provider via the computing device 104, so the healthcare provider may review the data object to review the one or more ranked locations, update the healthcare provider's servicing location in a directory based on the data object, and/or any other suitable actions or combinations thereof.

More specifically, the central server 102 includes one or more processors 102a, the memory 102b, and a networking interface 102c. The memory 102b stores executable instructions that are configured to, when executed by the one or more processors 102a, cause the one or more processors 102a to analyze data (e.g., data set 104b1, 106b1) received at the central server 102 and output various values (e.g., data objects indicating one or more ranked locations). The data validation application 102b1, the machine learning model 102b2, the dynamic period algorithm 102b3, and the application data 102b4 may all include such executable instructions, as well as other data. The memory 102b may also store additional data and/or databases. It should be appreciated that the central server 102 can include one or multiple computing devices that are co-located or distributed. Additionally, in certain embodiments, the data validation application 102b1 includes the dynamic period algorithm 102b3.

The central server 102 receives data set 104b1 from the computing device 104 connected to the server 102 through a network 108 and processes the data set 104b1 in accordance with one or more sets of instructions stored in a memory 102b to output any of the values described herein. The central server 102 executes the data validation application 102b1, which in turn, accesses and applies the machine learning model 102b2, the dynamic period algorithm 102b3, and/or the application data 102b4 to the data set 104b1. The data set 104b1 generally includes entity data that includes one or more locations corresponding to the entity at respective times. For example, the data set 104b1 may include entity data comprising one or more pre-adjudicated claims forms/documents (e.g., 837 claims) indicating that (1) the entity is a healthcare provider, (2) a potential location of the healthcare provider on the dates associated with the one or more pre-adjudicated claims forms/documents is “XYZ Street, Chicago, IL 60606”, and (3) a potential contact number associated with the healthcare provider is “(111) 222-3333”. Some/all of this information may eventually be stored in a location database, which may be included as part of the application data 102b4 and/or stored in an external storage location (e.g., external server 106).

In certain embodiments, the entity data includes entity type data, which delineates between/among various entities that are associated with one or more of the services indicated by the entity data. For example, the entity data may include a plurality of pre-adjudicated 837 claims forms/documents, wherein one or more of the claims forms/documents are associated with (i.e., submitted by) a first healthcare provider and one or more of the claims forms/documents are submitted by a second healthcare provider. The entity type data in this example indicates that the first healthcare provider is a cardiologist associated with hospital A and that the second healthcare provider is a general practitioner associated with hospital B. As another example, the entity type data may include or reference a healthcare provider's National Provider Identifier (NPI), which is a 10-position, intelligence-free numeric identifier. Of course, it should be appreciated that any suitable identification information may be included as part of the entity type data and/or otherwise utilized as part of the data validation application 102b1 execution, as described herein.

In certain embodiments, the data included in the data set 104b1 is or includes a text string, an audio stream, a video stream, a file, a document, and/or any other suitable data/datatype(s) or combinations thereof. Accordingly, in these embodiments, the data set 104b1 is or includes a set of such text strings, audio streams, video streams, files, documents, and/or any other suitable data/datatype(s) or combinations thereof.

The data validation application 102b1 receives the data set 104b1 and generates data objects indicating one or more ranked locations by accessing/applying the dynamic period algorithm 102b3 and the machine learning model 102b2 to the data set 104b1. The ranked locations generally indicate/represent one or more likely locations (e.g., current servicing location) for an entity based on the entity data included as part of the data set 104b1. The dynamic period algorithm 102b3 analyzes the entity data of the data set 104b1 to determine one or more periods of time that are relevant to determining the entity's servicing location. The machine learning model 102b2 then utilizes the entity data and one or more periods as inputs to determine confidence values for locations included in the entity data and the one or more periods and to output rankings for each location based on the confidence values (e.g., with the highest confidence value getting the highest ranking). With the locations and rankings, the data validation application 102b1 generates data objects indicating one or more ranked locations.

In certain embodiments, the machine learning model 102b2 is stored in a remote location from the central server 102 (e.g., a cloud-based server). In these embodiments, the data validation application 102b1 accesses the trained machine learning model 102b2 by transmitting inputs (e.g., entity data and time periods) to the cloud-based server. The trained machine learning model 102b2 analyzes the inputs, generates outputs (e.g., confidence values, location rankings), and the cloud-based server returns these outputs to the data validation application 102b1.

More generally, the computing device 104 is or includes any device that is associated with (e.g., owned and/or operated by) a particular entity that may provide data (e.g., data set 104b1) that is transmitted to and/or is otherwise accessible by the central server 102 and/or the external server 106 through the network 108. In certain embodiments, the data set 104b1 transmitted to and/or otherwise accessible by the central server 102 and/or the external server 106 is a set of claims (e.g., pre-adjudicated 837 claims) including potential locations associated with the user of the computing device 104 to be evaluated by the central server 102 and/or the external server 106. In some embodiments, the computing device 104 is a server or collection of servers hosting the data set 104b1. However, in certain embodiments, the computing device 104 is a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 includes a processor 104a, a memory 104b, a networking interface 104c, and a display 104d. The memory 104b stores the data set 104b1.

The computing device 104 is communicatively coupled to the central server 102 and/or the external server 106. For example, the computing device 104, the central server 102, and/or the external server 106 may communicate via USB, Bluetooth, Wi-Fi Direct, Near Field Communication (NFC), etc. For example, the central server 102 may transmit a data object indicating one or more ranked locations, confidence values, entity type data, periods, and/or any other values or combinations thereof to the computing device 104 via the networking interface 102c, which the computing device 104 may receive via the networking interface 104c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 includes a data set 106b1 including data from the computing device 104 and/or the central server 102. In one such example, the external server 106 is a server located in and/or otherwise associated with a hospital or other healthcare provider, and the data set 106b1 includes electronic health records in memory 106b. As another example, the external server 106 serves as a database for some or all of the application data 102b4. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid state memory) and may store one or more applications, modules, and/or models, such as the data validation application 102b1.

The networking interface 102c may enable the central server 102 to communicate with the computing device 104, the external server 106, and/or any other suitable devices or combinations thereof. More specifically, the networking interface 102c enables the central server 102 to communicate with each component of the example computing system 100 across the network 108 through their respective networking interfaces 104c, 106c. The networking interfaces 102c, 104c, 106c may support wired or wireless communications, such as USB, Bluetooth, Wi-Fi Direct, Near Field Communication (NFC), etc. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

### Example Dynamic Data Validation Workflows

FIG. 2A depicts an example dynamic data validation workflow 200, in accordance with various embodiments described herein. The example dynamic data validation workflow 200 broadly illustrates a sequence of actions, which may be performed by central server 102 (e.g., processor 102a and/or other components of central server 102) of FIG. 1, for example, to generate/determine time periods, confidence values, location rankings, data objects, and to update location values in a location database. The example dynamic data validation workflow 200 illustrated in FIG. 2A is for the purposes of discussion only, and additional/alternative dynamic data validation sequences may also, or instead, be utilized.

The dynamic data validation workflow 200 includes receiving entity data (block 202). The received entity data generally includes data identifying the entity, a location associated with the entity, and a date/time associated with the location. For example, the entity data may be or include a pre-adjudicated 837 claim indicating a healthcare provider located at “102 Maple Avenue Suite B” as of Apr. 1, 2024. In certain embodiments, the entity data is self-reported by the entity. In some embodiments, the entity data is received from another data source that is not the entity. Further, in some embodiments, the entity data includes data associated with a plurality of entities. For example, entity data received at the data validation application may include pre-adjudicated 837 claims data associated with a first healthcare provider and a second healthcare provider. Of course, it should be appreciated that the entity data may include data associated with any suitable number of entities.

Additionally, the received entity data generally includes data that is current/recent but may include data from any suitable date. For example, the received entity data may represent a set of healthcare claims data (e.g., pre-adjudicated 837 claims) submitted within the prior day or several days relative to the execution date of the data validation application, dynamic period algorithm, and machine learning model. The application may receive the entity data and determine (e.g., via dynamic period algorithm) that additional data is required for one or more entities. The application may then request, access, retrieve, and/or otherwise receive additional entity data corresponding to the one or more entities from, for example, the computing device (e.g., computing device 104) that transmitted the recently received entity data and/or from a local storage location (e.g., application data 102b4). Thus, as the entity data is analyzed in subsequent steps of the dynamic data validation workflow 200, the entity data may include the received (i.e., current/recent) entity data and any additional entity data requested, accesses, retrieved, and/or otherwise received based on determinations of the dynamic period algorithm and/or the machine learning model.

In certain embodiments, the entity data is received in a non-standardized format. Such non-standardized format may be dependent on the specific software and/or hardware platform(s) utilized by the entity and/or other entit(ies) submitting the entity data. For example, in the healthcare industry, various records (e.g., patient records) and/or other forms are frequently stored locally in accordance with the specific hardware or software platform in use at the local office/location. Some healthcare provider systems may utilize and/or allow the use of abbreviations and/or separate portions of addresses or other information into independent or subdivided fields, while other systems have substantially different permissions and/or data entry conventions. Moreover, certain healthcare provider systems are more optimally configured to identify and/or fix typographical errors, resulting in different rates and degrees of misspellings in received entity data. Overall, these data formatting inconsistencies/variations pose significant challenges to conventional techniques, as such conventional techniques generally lack the ability to process data from sources that employ different formatting conventions and therefore lack the ability to accurately consolidate the data received from these healthcare systems. As previously mentioned, these issues lead to inconsistencies between the listed address or contact information for a healthcare provider in a directory and the provider's actual servicing location, which results in patients being unable to locate their healthcare provider and thereby receiving less treatment.

Consequently, in the above-referenced embodiments, the example dynamic data validation workflow 200 standardizes the received entity data. This entity data standardization is an initial step as part of block 204. Standardizing the received entity data generally includes executing a data validation application (e.g., data validation application 102b1) and executable instructions included therein that are configured to remove abbreviations, adjust street names/numbers into a standard location, and/or other actions or combinations thereof. As an example, the dynamic data validation systems described herein may receive the three locations “102B Maple Ave”, “102 Maple Ave, Suite B”, and “102 Maple Suite B” in the received entity data and/or one of these locations may be recorded in a location database as the address/location of record. In this example, the data validation application standardizes each of these locations to “102 Maple Avenue Suite B”. If this location is determined to be the servicing location for the corresponding entity, the data validation application will then store the location in the location database.

In certain instances, the data validation application receives entity data that is a new non-standardized format. In these instances, the application determines a mapping between the non-standardized format and the standardized format. For example, the application may execute an optical character recognition (OCR) engine and/or other suitable algorithm configured to recognize data included as part of the received, non-standardized data, and may save this mapping as part of the application data (e.g., application data 102b4). The mapping generally maps values extracted and recognized via execution of the OCR algorithm or similar process to known fields of the standardized format. Thus, when the application receives subsequent entity data in the particular non-standardized format, the application may recognize the non-standardized format and apply the mapping to the data included in the subsequent entity data to quickly convert the non-standardized data to the standardized format.

With the standardized data, the dynamic data validation workflow 200 further includes determining (at block 204) time periods using a dynamic period algorithm (e.g., dynamic period algorithm 102b3). The algorithm determines one or more periods based on the received entity data, and at least one of the determined periods includes a time indicated in the received entity data. In particular, the dynamic period algorithm determines one or more time periods that extend back in time from the algorithm run date (i.e., the current date). As discussed herein in reference to FIG. 2B, the application may iteratively adjust each time period to longer or shorter durations to improve the machine learning model performance. Accordingly, the determined time period may be different for each algorithm run date based on the machine learning model performance, such that the dynamic period algorithm dynamically determines the best time period for each distinct execution of the algorithm and machine learning model.

The dynamic data validation workflow 200 further includes (at block 204) assigning a frequency to each location appearing within the entity data for every entity represented therein. In particular, the data validation application includes computer-executable instructions that cause the processors to, for each location of each respective entity, count/record the number of times that a particular location for a respective entity appeared within the received entity data. For example, Dr. Doe associated with NPI 123456789 may have multiple locations indicated in the received entity data, and the dynamic period algorithm may determine a first time period (e.g., 2 months from the algorithm run date) and a second time period (e.g., 4 months from the algorithm run date). The data validation application may then identify: “123 Main Street, Evanston Illinois 60201” appears 2 times in a first time period and 26 times in a second time period, “456 South Lane, Chicago Illinois 60606” appears 21 times in the first time period and 23 times in the second time period, and “789 Left Road, Palos Park Illinois 60464” appears 4 times in the first time period and 9 times in the second time period.

This data then serves as input (at block 206) to a machine learning model (e.g., machine learning model 102b2) that is trained/configured to determine a confidence value and corresponding ranking for each location of each entity. These machine learning model generally makes these confidence value determinations based on both the frequency with which the location appears in the one or more periods and a period distance value relating the current time to the one or more periods. In certain embodiments, the period distance value is a difference between a current time and an earliest time included in the one or more periods. In the prior example, the machine learning model may determine/analyze frequencies for each of the locations associated with Dr. Doe, and may calculate time differences between the date when each instance of the particular locations appeared in the entity data and the current date. The machine learning model subsequently uses these differences (i.e., period distance values) as weights or adjustment parameters to indicate the relevance of the particular dates. As such, location instances that occurred very recently will more heavily influence the model's determination of an entity's current servicing location than location instances that occurred significantly less recently.

More specifically, the machine learning model determines a likelihood of each location being a current servicing location based on the frequency counts within each time period in conjunction with the distance of the time period from the algorithm run date. Continuing the prior example, the machine learning model may analyze the entity data to determine that the “123 Main Street” location is highly unlikely to be Dr. Doe's servicing location because the location appears significantly less frequently in more recent claims data than in older claims data. Namely, the “123 Main Street” location appears 2 times in first period and appears 26 times in second period, 24 of which are not included in the first period (i.e., 2 distinct appearances in first two months and 24 distinct appearances in second two months). The machine learning model may also determine that the “789 Left Road” location is relatively unlikely to be Dr. Doe's servicing location because the location appears infrequently throughout both the first period and second period. However, the machine learning model may determine that the “456 South Lane” location is likely to be Dr. Doe's servicing location because the location appears significantly more frequently in more recent claims data than in older claims data. Namely, the “456 South Lane” location appears 21 times in first period and appears 23 times in second period, only 2 of which are not included in the first period (i.e., 21 distinct appearances in first two months and 2 distinct appearances in second two months).

Accordingly, the machine learning model may determine confidence intervals for each individual location. Still further in the prior example, the machine learning model may determine that the “456 South Lane” location has a 95% confidence value associated with being Dr. Doe's servicing location, the “789 Left Road” location has a 50% confidence value associated with being Dr. Doe's servicing location, and the “123 Main Street” location has a 11% confidence value associated with being Dr. Doe's servicing location. The machine learning model then outputs rankings corresponding to each location based on the respective confidence values. For example, the “456 South Lane” location may receive a top, highest, or first place ranking because the 95% confidence value is higher than any other confidence value associated with Dr. Doe, the “789 Left Road” location may receive a middle ranking because the 50% confidence value is neither the highest nor the lowest confidence value associated with Dr. Doe, and the “123 Main Street” location may receive a bottom, lowest, or last place ranking because the 11% confidence value is lower than any other confidence value associated with Dr. Doe.

The machine learning model and/or other computer-executable instructions included as part of the data validation application then compare(s) the entity's self-reported servicing location (e.g., stored in a location database) to the confidence values and rankings (block 208). If the stored servicing location matches (e.g., satisfies a location threshold) with any of the ranked locations output by the machine learning model (Yes branch of block 208), the address is then considered validated (block 210). If the stored servicing location does not match (e.g., fails to satisfy the location threshold) with any of the ranked locations output by the machine learning model (No branch of block 208), the data validation application updates the location database for the entity with the most likely address(es) output by the machine learning model (block 212). In certain embodiments, this dynamic data validation workflow 200 executes daily upon receipt of new entity data, with new dynamic time periods determined each day by the dynamic period algorithm. Of course, it should be appreciated that the data validation application and/or other suitable processing components may execute the dynamic data validation workflow 200 any suitable number of times with any suitable frequency (e.g., hourly, daily, weekly, monthly, etc.).

FIG. 2B depicts an example dynamic time period determination and location ranking workflow 220 that illustrates the actions performed as part of block 204 in FIG. 2A, in accordance with various embodiments described herein. The input of the workflow 220 is event data indicating events associated with one or more users, and the output of the workflow 220 is one or more embeddings associated with unique event combination(s). Any of the actions/steps described with reference to FIG. 2B may be performed by central server 102 (e.g., processor 102a and/or other components of central server 102) of FIG. 1, and/or any other suitable processor or combinations thereof.

Initially, the workflow 220 includes receiving entity data that includes one or more locations corresponding to the entity at one or more respective times. For example, the received entity data may include two healthcare claim documents corresponding to a Dr. Smith, a first document indicating a date of May 4, 2024 and a second document indicating a date of May 3, 2024. As previously mentioned, the entity data may include additional information, such as entity type data (e.g., indicating Dr. Smith is a radiologist at a first hospital, pediatrician at a second hospital, etc.), and entity's identification credentials (e.g., Dr. Smith's NPI value), and/or other data or combinations thereof.

The workflow 220 then includes executing the dynamic period algorithm to determine one or more periods based on the entity data (block 221a). This process is more acutely illustrated at block 222, where the dynamic period algorithm (e.g., algorithm 102b3 from FIG. 1) evaluates periods of time extending back from the algorithm run date (i.e., current date) to determine one or more periods of interest. In particular, the dynamic period algorithm evaluates the received claim data in combination with any additional claim data from required to determine an optimal time period for each entity indicated in the entity data. As illustrated in block 222, the dynamic period algorithm iteratively analyzes additional entity data (e.g., on a month-by-month basis) within iteratively expanding periods (e.g., 1 month, 2 months, 3 months, etc.) until the dynamic period algorithm determines that one or more periods includes sufficient and/or an optimal amount of data to determine the current servicing location of the entity (illustrated by arrow 222a). For example, the dynamic period algorithm may determine that the entity data 222b included in the first two months period 221cl extending back from the current date included sufficient and/or an optimal amount of entity data to determine an entity's servicing location. The dynamic period algorithm may further determine that the remaining available entity data extending back to 18 months before the current date (e.g., period 221c2) may be input to the machine learning model in the event that two or more locations identified within the entity data from the first two months period 221cl are equally likely to be an entity's servicing location. The dynamic period algorithm may determine one or more different periods for each entity indicated in the entity data.

To make these period determinations, the dynamic period algorithm receives feedback from the machine learning model indicating whether particular periods for an entity produced the correct servicing location. The machine learning model and/or the dynamic period algorithm analyzes this feedback to further determine correlations between the particular periods and aspects of the entity data. For example, the machine learning model may determine that the entity data included in the one or more periods determined by the dynamic period algorithm did not yield a location that satisfied the location threshold (e.g., 85% confidence) and may generate feedback to correct this issue. In certain embodiments, the machine learning model determines correlations between the entity data and the confidence values/location rankings to adjust the operation of the dynamic period algorithm during subsequent iterations.

For example, the dynamic period algorithm may determine one or more periods for a surgeon at a particular hospital, which may not result in a servicing location when analyzed by the machine learning model. The machine learning model then generates feedback indicating that the dynamic period algorithm should determine periods extending further back into the past to include additional entity data for surgeons and/or practitioners at the particular hospital. During subsequent iterations, the dynamic period algorithm may then adjust the one or more periods input to the machine learning model based on this feedback to include more prior entity data for surgeons and/or practitioners at the particular hospital.

When the dynamic period algorithm determines the one or more periods, the algorithm transmits these periods and the entity data to the machine learning model as inputs. The machine learning model then analyzes these inputs (periods and entity data) to output location rankings (block 221b). Generally speaking, machine learning may be implemented through machine learning methods and algorithms. In certain embodiments, the machine learning model(s) utilized as part of block 221b is or includes a supervised random forest model configured/trained to determine confidence values and location rankings for locations included in the input entity data based on the one or more periods received from the dynamic period algorithm.

In certain embodiments, the machine learning models described herein (e.g., ML model 102b2) employ supervised learning, which involves identifying patterns in existing data to make predictions about subsequently received data. Specifically, the machine learning models may be “trained” using training data, which includes example inputs and associated example outputs. Based upon the training data, the machine learning models generate a predictive function which maps outputs to inputs and utilize the predictive function to generate machine learning outputs based upon data inputs. The example inputs and example outputs of the training data may include any of the data inputs or machine learning outputs described above. In the exemplary embodiment, a processing element may be trained by providing it with a large sample of data with known characteristics or features. In various embodiments, the implemented machine learning methods and algorithms are directed toward at least one of a plurality of categorizations of machine learning, such as supervised learning.

In some embodiments, the ML models described herein (e.g., ML model 102b2) employ unsupervised learning, which involves finding meaningful relationships in unorganized data. Unlike supervised learning, unsupervised learning does not involve user-initiated training based upon example inputs with associated outputs/labels. Rather, in unsupervised learning, the machine learning model organizes unlabeled data according to a relationship determined by at least one machine learning method/algorithm employed by the machine learning model. Unorganized data may include any combination of data inputs and/or machine learning outputs, as described above.

Additionally, or alternatively, the machine learning models described herein may utilize or include natural language processing (NLP) functionality. For example, the entity data may be or include healthcare claims data, and the machine learning model may implement NLP algorithms/models to interpret the text included therein when determining the confidence values and location rankings.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the machine learning model described herein may be used to output confidence values, location rankings, data objects, and/or any other values, responses, or combinations thereof using artificial intelligence (e.g., a machine learning model of the machine learning model 102b2) or, in alternative aspects, without using artificial intelligence.

### Example Computer-Implemented Methods

FIG. 3 depicts a flow diagram representing an example computer-implemented method 300, in accordance with various embodiments described herein. The method 300 may be implemented by one or more processors of the example computing system 100, such as the processor 102a of central server 102 (e.g., by data validation application 102b1), for example.

The method 300 includes receiving entity data associated with an entity (block 302). The entity data includes one or more locations of the entity at respective times. The method 300 further includes determining, by executing a dynamic period algorithm, one or more periods based on the entity data (block 304). At least one of the one or more periods includes at least one of the respective times.

The method 300 further includes applying a machine learning model to the entity data and the one or more periods to determine, for at least one period of the one or more periods, one or more confidence values (block 306). The one or more confidence values are associated with each location at the respective times included in the at least one period based on (i) a frequency associated with each location and (ii) a period distance value relating a current time to the at least one period. The method 300 further includes applying the machine learning model to output a ranking for each location included in the at least one period based on the one or more confidence values (block 308). The method 300 further includes generating a data object indicating one or more of the ranked locations (block 310).

In certain embodiments, the period distance value is a difference between a current time and an earliest time included in the at least one period.

In certain embodiments, the method 300 further includes extracting the entity data from a data file; determining (i) one or more non-standardized values within the entity data and (ii) a mapping to convert the one or more non-standardized values from a non-standardized format to a standardized format; and converting the one or more non-standardized values from the non-standardized format to the standardized format.

In certain embodiments, the entity data includes a plurality of locations corresponding to the entity at the respective times.

In certain embodiments, the machine learning model is trained using (i) a plurality of training entity data corresponding to a plurality of entities and (ii) a plurality of training periods as inputs to output (a) rankings of locations included in the plurality of training entity data and (b) one or more optimal periods from the plurality of training periods.

In certain embodiments, each optimal period of the one or more optimal periods corresponds to a respective entity type included in the plurality of entities.

In certain embodiments, the dynamic period algorithm is configured to determine the one or more periods based on (i) the entity data and (ii) an optimal period of the one or more optimal periods corresponding to the respective entity type associated with the entity.

In certain embodiments, the method 300 further includes applying the machine learning model to (i) new entity data and (ii) one or more new periods to determine one or more new optimal periods for one or more respective entity types included in the plurality of entities.

In certain embodiments, the dynamic period algorithm determines a plurality of periods based on the entity data, and applying the machine learning model further comprises: determining, for each period of the plurality of periods, a confidence value associated with each location included in each period of the plurality of periods based on (i) a frequency associated with each location and (ii) a period distance value associated with each period of the plurality of periods, and outputting a ranking for each location included in each period of the plurality of periods based on respective confidence values.

In certain embodiments, the method 300 further includes (a) determining that each confidence value fails to satisfy a confidence threshold value; (b) determining, by executing the dynamic period algorithm, one or more additional periods based on the entity data; (c) applying the machine learning model to determine, for each period of the one or more additional periods, one or more respective confidence values associated with each location included in each period of the one or more additional periods based on (i) a respective frequency associated with each location and (ii) a respective period distance value associated with each period of the one or more additional periods, and output a respective ranking for each location included in each period of the one or more additional periods based on the one or more respective confidence values; (d) iteratively performing steps (a)-(c) until at least one respective confidence value satisfies the confidence threshold value; and generating the data object indicating a ranked location corresponding with the at least one respective confidence value.

In certain embodiments, the method 300 further includes determining a location value associated with the entity in a location database is different from a highest ranked location from the at least one period that has a highest confidence value of the one or more confidence values; and updating the location value in the location database to include the highest ranked location.

In certain embodiments, the machine learning model is a trained random forest model.

Of course, it is to be appreciated that the actions of the method 300 may be performed any suitable number of times, and that the actions described in reference to the method 300 may be performed in any suitable order.

### EXAMPLES

Example 1. A computer-implemented method comprising: receiving, by one or more processors, entity data associated with an entity, the entity data including one or more locations of the entity at respective times; determining, by the one or more processors executing a dynamic period algorithm, one or more periods based on the entity data, wherein at least one of the one or more periods includes at least one of the respective times; applying, by the one or more processors, a machine learning model to the entity data and the one or more periods, wherein applying the machine learning model includes determining, for at least one period of the one or more periods, one or more confidence values associated with each location at the respective times included in the at least one period based on (i) a frequency associated with each location and (ii) a period distance value relating a current time to the at least one period, and outputting a ranking for each location included in the at least one period based on the one or more confidence values; and generating, by the one or more processors, a data object indicating one or more of the ranked locations.

Example 2. The computer-implemented method of Example 1, wherein the period distance value is a difference between a current time and an earliest time included in the at least one period.

Example 3. The computer-implemented method of any of Examples 1 or 2, further comprising: extracting, by the one or more processors, the entity data from a data file; determining, by the one or more processors, (i) one or more non-standardized values within the entity data and (ii) a mapping to convert the one or more non-standardized values from a non-standardized format to a standardized format; and converting, by the one or more processors, the one or more non-standardized values from the non-standardized format to the standardized format.

Example 4. The computer-implemented method of any of Examples 1 through 3, wherein the entity data includes a plurality of locations corresponding to the entity at the respective times.

Example 5. The computer-implemented method of any of Examples 1 through 4, wherein the machine learning model is trained using (i) a plurality of training entity data corresponding to a plurality of entities and (ii) a plurality of training periods as inputs to output (a) rankings of locations included in the plurality of training entity data and (b) one or more optimal periods from the plurality of training periods.

Example 6. The computer-implemented method of Example 5, wherein each optimal period of the one or more optimal periods corresponds to a respective entity type included in the plurality of entities.

Example 7. The computer-implemented method of Example 6, wherein the dynamic period algorithm is configured to determine the one or more periods based on (i) the entity data and (ii) an optimal period of the one or more optimal periods corresponding to the respective entity type associated with the entity.

Example 8. The computer-implemented method of Examples 6 or 7, further comprising: applying, by the one or more processors, the machine learning model to (i) new entity data and (ii) one or more new periods to determine one or more new optimal periods for one or more respective entity types included in the plurality of entities.

Example 9. The computer-implemented method of any of Examples 1 through 8, wherein the dynamic period algorithm determines a plurality of periods based on the entity data, and applying the machine learning model further comprises: determining, for each period of the plurality of periods, a confidence value associated with each location included in each period of the plurality of periods based on (i) a frequency associated with each location and (ii) a period distance value associated with each period of the plurality of periods, and outputting a ranking for each location included in each period of the plurality of periods based on respective confidence values.

Example 10. The computer-implemented method of any of Examples 1 through 9, further comprising: (a) determining, by the one or more processors, that each confidence value fails to satisfy a confidence threshold value; (b) determining, by the one or more processors executing the dynamic period algorithm, one or more additional periods based on the entity data; (c) applying, by the one or more processors, the machine learning model to determine, for each period of the one or more additional periods, one or more respective confidence values associated with each location included in each period of the one or more additional periods based on (i) a respective frequency associated with each location and (ii) a respective period distance value associated with each period of the one or more additional periods, and output a respective ranking for each location included in each period of the one or more additional periods based on the one or more respective confidence values; (d) iteratively performing steps (a)-(c) until at least one respective confidence value satisfies the confidence threshold value; and generating, by the one or more processors, the data object indicating a ranked location corresponding with the at least one respective confidence value.

Example 11. The computer-implemented method of any of Examples 1 through 10, further comprising: determining, by the one or more processors, a location value associated with the entity in a location database is different from a highest ranked location from the at least one period that has a highest confidence value of the one or more confidence values; and updating, by the one or more processors, the location value in the location database to include the highest ranked location.

Example 12. The computer-implemented method of any of Examples 1 through 11, wherein the machine learning model is a trained random forest model.

Example 13. A system comprising memory and one or more processors communicatively coupled to the memory, the one or more processors configured to: receive entity data associated with an entity, the entity data including one or more locations of the entity at respective times; determine, by executing a dynamic period algorithm, one or more periods based on the entity data, wherein at least one of the one or more periods includes at least one of the respective times; apply a machine learning model to the entity data and the one or more periods, wherein applying the machine learning model includes determining, for at least one period of the one or more periods, one or more confidence values associated with each location at the respective times included in the at least one period based on (i) a frequency associated with each location and (ii) a period distance value relating a current time to the at least one period, and outputting a ranking for each location included in the at least one period based on the one or more confidence values; and generate a data object indicating one or more of the ranked locations.

Example 14. The system of Example 13, wherein the period distance value is a difference between a current time and an earliest time included in the at least one period.

Example 15. The system of any of Examples 13 or 14, wherein the one or more processors are further configured to: extract the entity data from a data file; determine (i) one or more non-standardized values within the entity data and (ii) a mapping to convert the one or more non-standardized values from a non-standardized format to a standardized format; and convert the one or more non-standardized values from the non-standardized format to the standardized format.

Example 16. The system of any of Examples 13 through 15, wherein the entity data includes a plurality of locations corresponding to the entity at the respective times.

Example 17. The system of any of Examples 13 through 16, wherein the machine learning model is trained using (i) a plurality of training entity data corresponding to a plurality of entities and (ii) a plurality of training periods as inputs to output (a) rankings of locations included in the plurality of training entity data and (b) one or more optimal periods from the plurality of training periods.

Example 18. The system of Example 17, wherein each optimal period of the one or more optimal periods corresponds to a respective entity type included in the plurality of entities.

Example 19. The system of Example 18, wherein the dynamic period algorithm is configured to determine the one or more periods based on (i) the entity data and (ii) an optimal period of the one or more optimal periods corresponding to the respective entity type associated with the entity.

Example 20. The system of Examples 18 or 19, wherein the one or more processors are further configured to: apply the machine learning model to (i) new entity data and (ii) one or more new periods to determine one or more new optimal periods for one or more respective entity types included in the plurality of entities.

Example 21. The system of any of Examples 13 through 20, wherein the dynamic period algorithm determines a plurality of periods based on the entity data, and the one or more processors are further configured to apply the machine learning model by: determining, for each period of the plurality of periods, a confidence value associated with each location included in each period of the plurality of periods based on (i) a frequency associated with each location and (ii) a period distance value associated with each period of the plurality of periods, and outputting a ranking for each location included in each period of the plurality of periods based on respective confidence values.

Example 22. The system of any of Examples 13 through 21, wherein the one or more processors are further configured to: (a) determine that each confidence value fails to satisfy a confidence threshold value; (b) determine, by executing the dynamic period algorithm, one or more additional periods based on the entity data; (c) apply the machine learning model to determine, for each period of the one or more additional periods, one or more respective confidence values associated with each location included in each period of the one or more additional periods based on (i) a respective frequency associated with each location and (ii) a respective period distance value associated with each period of the one or more additional periods, and output a respective ranking for each location included in each period of the one or more additional periods based on the one or more respective confidence values; (d) iteratively perform steps (a)-(c) until at least one respective confidence value satisfies the confidence threshold value; and generate the data object indicating a ranked location corresponding with the at least one respective confidence value.

Example 23. The system of any of Examples 13 through 22, wherein the one or more processors are further configured to: determine a location value associated with the entity in a location database is different from a highest ranked location from the at least one period that has a highest confidence value of the one or more confidence values; and update the location value in the location database to include the highest ranked location.

Example 24. The system of any of Examples 13 through 23, wherein the machine learning model is a trained random forest model.

Example 25. One or more non-transitory computer-readable storage media including instructions that, when executed by one or more processors, cause the one or more processors to: receive entity data associated with an entity, the entity data including one or more locations of the entity at respective times; determine, by executing a dynamic period algorithm, one or more periods based on the entity data, wherein at least one of the one or more periods includes at least one of the respective times; apply a machine learning model to the entity data and the one or more periods, wherein applying the machine learning model includes determining, for at least one period of the one or more periods, one or more confidence values associated with each location at the respective times included in the at least one period based on (i) a frequency associated with each location and (ii) a period distance value relating a current time to the at least one period, and outputting a ranking for each location included in the at least one period based on the one or more confidence values; and generate a data object indicating one or more of the ranked locations.

Example 26. The one or more non-transitory computer-readable storage media of Example 25, wherein the period distance value is a difference between a current time and an earliest time included in the at least one period.

Example 27. The one or more non-transitory computer-readable storage media of Example 25 or 26, wherein the instructions, when executed by the one or more processors, further cause the one or more processors to: extract the entity data from a data file; determine (i) one or more non-standardized values within the entity data and (ii) a mapping to convert the one or more non-standardized values from a non-standardized format to a standardized format; and convert the one or more non-standardized values from the non-standardized format to the standardized format.

Example 28. The one or more non-transitory computer-readable storage media of any of Examples 25 through 27, wherein the entity data includes a plurality of locations corresponding to the entity at the respective times.

Example 29. The one or more non-transitory computer-readable storage media of any of Examples 25 through 28, wherein the machine learning model is trained using (i) a plurality of training entity data corresponding to a plurality of entities and (ii) a plurality of training periods as inputs to output (a) rankings of locations included in the plurality of training entity data and (b) one or more optimal periods from the plurality of training periods.

Example 30. The one or more non-transitory computer-readable storage media of Example 29, wherein each optimal period of the one or more optimal periods corresponds to a respective entity type included in the plurality of entities.

Example 31. The one or more non-transitory computer-readable storage media of Example 30, wherein the dynamic period algorithm is configured to determine the one or more periods based on (i) the entity data and (ii) an optimal period of the one or more optimal periods corresponding to the respective entity type associated with the entity.

Example 32. The one or more non-transitory computer-readable storage media of Examples 30 or 31, wherein the instructions, when executed by the one or more processors, further cause the one or more processors to: apply the machine learning model to (i) new entity data and (ii) one or more new periods to determine one or more new optimal periods for one or more respective entity types included in the plurality of entities.

Example 33. The one or more non-transitory computer-readable storage media of any of Examples 25 through 32, wherein the dynamic period algorithm determines a plurality of periods based on the entity data, and wherein the instructions, when executed by the one or more processors, further cause the one or more processors to apply the machine learning model by: determining, for each period of the plurality of periods, a confidence value associated with each location included in each period of the plurality of periods based on (i) a frequency associated with each location and (ii) a period distance value associated with each period of the plurality of periods, and outputting a ranking for each location included in each period of the plurality of periods based on respective confidence values.

Example 34. The one or more non-transitory computer-readable storage media of any of Examples 25 through 33, wherein the instructions, when executed by the one or more processors, further cause the one or more processors to: (a) determine that each confidence value fails to satisfy a confidence threshold value; (b) determine, by executing the dynamic period algorithm, one or more additional periods based on the entity data; (c) apply the machine learning model to determine, for each period of the one or more additional periods, one or more respective confidence values associated with each location included in each period of the one or more additional periods based on (i) a respective frequency associated with each location and (ii) a respective period distance value associated with each period of the one or more additional periods, and output a respective ranking for each location included in each period of the one or more additional periods based on the one or more respective confidence values; (d) iteratively perform steps (a)-(c) until at least one respective confidence value satisfies the confidence threshold value; and generate the data object indicating a ranked location corresponding with the at least one respective confidence value.

Example 35. The one or more non-transitory computer-readable storage media of any of Examples 25 through 34, wherein the instructions, when executed by the one or more processors, further cause the one or more processors to: determine a location value associated with the entity in a location database is different from a highest ranked location from the at least one period that has a highest confidence value of the one or more confidence values; and update the location value in the location database to include the highest ranked location.

Example 36. The one or more non-transitory computer-readable storage media of any of Examples 25 through 35, wherein the machine learning model is a trained random forest model.

Example 37. The computer-implemented method of Example 1, wherein training of the machine learning model is performed by the one or more processors.

Example 38. The computer-implemented method of Example 1, wherein: the one or more processors are included in a first computing entity; and training of the machine learning model is performed by one or more processors included in a second computing entity.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, entity data associated with an entity, the entity data including one or more locations of the entity at respective times;
determining, by the one or more processors executing a dynamic period algorithm, one or more periods based on the entity data, wherein at least one of the one or more periods includes at least one of the respective times;
applying, by the one or more processors, a machine learning model to the entity data and the one or more periods, wherein applying the machine learning model includes
determining, for at least one period of the one or more periods, one or more confidence values associated with each location at the respective times included in the at least one period based on (i) a frequency associated with each location and (ii) a period distance value relating a current time to the at least one period, and
outputting a ranking for each location included in the at least one period based on the one or more confidence values; and
generating, by the one or more processors, a data object indicating one or more of the ranked locations.

2. The computer-implemented method of claim 1, wherein the period distance value is a difference between a current time and an earliest time included in the at least one period.

3. The computer-implemented method of claim 1, further comprising:
extracting, by the one or more processors, the entity data from a data file;
determining, by the one or more processors, (i) one or more non-standardized values within the entity data and (ii) a mapping to convert the one or more non-standardized values from a non-standardized format to a standardized format; and
converting, by the one or more processors, the one or more non-standardized values from the non-standardized format to the standardized format.

4. The computer-implemented method of claim 1, wherein the entity data includes a plurality of locations corresponding to the entity at the respective times.

5. The computer-implemented method of claim 1, wherein the machine learning model is trained using (i) a plurality of training entity data corresponding to a plurality of entities and (ii) a plurality of training periods as inputs to output (a) rankings of locations included in the plurality of training entity data and (b) one or more optimal periods from the plurality of training periods.

6. The computer-implemented method of claim 5, wherein each optimal period of the one or more optimal periods corresponds to a respective entity type included in the plurality of entities.

7. The computer-implemented method of claim 6, wherein the dynamic period algorithm is configured to determine the one or more periods based on (i) the entity data and (ii) an optimal period of the one or more optimal periods corresponding to the respective entity type associated with the entity.

8. The computer-implemented method of claim 6, further comprising:
applying, by the one or more processors, the machine learning model to (i) new entity data and (ii) one or more new periods to determine one or more new optimal periods for one or more respective entity types included in the plurality of entities.

9. The computer-implemented method of claim 1, wherein the dynamic period algorithm determines a plurality of periods based on the entity data, and applying the machine learning model further comprises:
determining, for each period of the plurality of periods, a confidence value associated with each location included in each period of the plurality of periods based on (i) a frequency associated with each location and (ii) a period distance value associated with each period of the plurality of periods, and
outputting a ranking for each location included in each period of the plurality of periods based on respective confidence values.

10. The computer-implemented method of claim 1, further comprising:
(a) determining, by the one or more processors, that each confidence value fails to satisfy a confidence threshold value;
(b) determining, by the one or more processors executing the dynamic period algorithm, one or more additional periods based on the entity data;
(c) applying, by the one or more processors, the machine learning model to
determine, for each period of the one or more additional periods, one or more respective confidence values associated with each location included in each period of the one or more additional periods based on (i) a respective frequency associated with each location and (ii) a respective period distance value associated with each period of the one or more additional periods, and
output a respective ranking for each location included in each period of the one or more additional periods based on the one or more respective confidence values;
(d) iteratively performing steps (a)-(c) until at least one respective confidence value satisfies the confidence threshold value; and
generating, by the one or more processors, the data object indicating a ranked location corresponding with the at least one respective confidence value.

11. The computer-implemented method of claim 1, further comprising:
determining, by the one or more processors, a location value associated with the entity in a location database is different from a highest ranked location from the at least one period that has a highest confidence value of the one or more confidence values; and
updating, by the one or more processors, the location value in the location database to include the highest ranked location.

12. The computer-implemented method of claim 1, wherein the machine learning model is a trained random forest model.

13. A system comprising memory and one or more processors communicatively coupled to the memory, the one or more processors configured to:
receive entity data associated with an entity, the entity data including one or more locations of the entity at respective times;
determine, by executing a dynamic period algorithm, one or more periods based on the entity data, wherein at least one of the one or more periods includes at least one of the respective times;
apply a machine learning model to the entity data and the one or more periods, wherein applying the machine learning model includes
determining, for at least one period of the one or more periods, one or more confidence values associated with each location at the respective times included in the at least one period based on (i) a frequency associated with each location and (ii) a period distance value relating a current time to the at least one period, and
outputting a ranking for each location included in the at least one period based on the one or more confidence values; and
generate a data object indicating one or more of the ranked locations.

14. The system of claim 13, wherein the period distance value is a difference between a current time and an earliest time included in the at least one period.

15. The system of claim 13, wherein the one or more processors are configured to:
extract the entity data from a data file;
determine (i) one or more non-standardized values within the entity data and (ii) a mapping to convert the one or more non-standardized values from a non-standardized format to a standardized format; and
convert the one or more non-standardized values from the non-standardized format to the standardized format.

16. The system of claim 13, wherein the machine learning model is trained using (i) a plurality of training entity data corresponding to a plurality of entities and (ii) a plurality of training periods as inputs to output (a) rankings of locations included in the plurality of training entity data and (b) one or more optimal periods from the plurality of training periods, and wherein each optimal period of the one or more optimal periods corresponds to a respective entity type included in the plurality of entities.

17. The system of claim 16, wherein the dynamic period algorithm is configured to determine the one or more periods based on (i) the entity data and (ii) an optimal period of the one or more optimal periods corresponding to the respective entity type associated with the entity, and wherein the one or more processors are configured to:
apply the machine learning model to (i) new entity data and (ii) one or more new periods to determine one or more new optimal periods for one or more respective entity types included in the plurality of entities.

18. The system of claim 13, wherein the dynamic period algorithm determines a plurality of periods based on the entity data, and the one or more processors are further configured to apply the machine learning model by:
determining, for each period of the plurality of periods, a confidence value associated with each location included in each period of the plurality of periods based on (i) a frequency associated with each location and (ii) a period distance value associated with each period of the plurality of periods, and
outputting a ranking for each location included in each period of the plurality of periods based on respective confidence values.

19. The system of claim 13, wherein the one or more processors are further configured to:
(a) determine that each confidence value fails to satisfy a confidence threshold value;
(b) determine, by executing the dynamic period algorithm, one or more additional periods based on the entity data;
(c) apply the machine learning model to
determine, for each period of the one or more additional periods, one or more respective confidence values associated with each location included in each period of the one or more additional periods based on (i) a respective frequency associated with each location and (ii) a respective period distance value associated with each period of the one or more additional periods, and
output a respective ranking for each location included in each period of the one or more additional periods based on the one or more respective confidence values;
(d) iteratively perform steps (a)-(c) until at least one respective confidence value satisfies the confidence threshold value; and
generate the data object indicating a ranked location corresponding with the at least one respective confidence value.

20. One or more non-transitory computer-readable storage media including instructions that, when executed by one or more processors, cause the one or more processors to:
receive entity data associated with an entity, the entity data including one or more locations of the entity at respective times;
determine, by executing a dynamic period algorithm, one or more periods based on the entity data, wherein at least one of the one or more periods includes at least one of the respective times;
apply a machine learning model to the entity data and the one or more periods, wherein applying the machine learning model includes
determining, for at least one period of the one or more periods, one or more confidence values associated with each location at the respective times included in the at least one period based on (i) a frequency associated with each location and (ii) a period distance value relating a current time to the at least one period, and
outputting a ranking for each location included in the at least one period based on the one or more confidence values; and
generate a data object indicating one or more of the ranked locations.
